(19) United States
(12) Patent Application Publication
(10) Pub. No.: US 2025/0344807 A1
(43) Pub. Date: Nov. 13, 2025

(54) PERSONALIZED FOOTWEAR ASSEMBLY WITH PANEL SYSTEM

(71) Applicant: Drake Labs, Inc., Seattle, WA (US)

(72) Inventors: Robert John Horacek, Park City, UT (US); Raymond Alfred Horacek, Yokohama (JP); Stephan Drake, Salt Lake City, UT (US)

(21) Appl. No.: 19/053,213

(22) Filed: Feb. 13, 2025

Related U.S. Application Data
(60) Provisional application No. 63/552,925, filed on Feb. 13, 2024.

(51) Int. Cl. A43B 13/14; A43B 23/02; B29D 35/12; B33Y 80/00

(52) U.S. Cl. CPC A43B 13/14; A43B 23/0295; B29D 35/122; B29D 35/126; B33Y 80/00

(57) ABSTRACT

A footwear assembly, such as a cycling show, includes a plantar shell assembly and a dorsal shell assembly. The plantar shell assembly includes a plantar shell shaped to conform to a bottom surface contour of the wearer's foot and a panel system include one or more engagement panels configured to contact medial, lateral, and/or dorsal surfaces of the wearer's foot. The dorsal shell assembly includes one or more dorsal shells shaped to conform to an upper surface contour of the wearer's foot. The dorsal shell assembly can be coupled to the plantar shell to apply a compressive force to the wearer's foot via the engagement panels and at least partially prevent movement of the wearer's foot relative to the plantar shell.

### CROSS-REFERENCE TO RELATED APPLICATION

This patent application claims the benefit of and priority to U.S. Provisional Patent Application No. 63/552,925, titled Personalized Footwear Assembly with Panel System, filed Feb. 13, 2024, which is incorporated herein in its entirety by reference thereto.

### TECHNICAL FIELD

Embodiments of the present invention are directed to footwear, and more particularly to personalized performance footwear systems with enhanced support, fit, and responsiveness for the wearer's feet.

### BACKGROUND

Footwear that properly fits a wearer's feet, particularly for high-performance activities, is extremely important. People's feet, ankles, and lower legs, however, are all different with different sizes, shapes, alignment, and/or relative motion during subtle and dynamic activities. Conventional footwear is typically constructed with a small range of sizes (lengths and widths), so each size can generally fit a wide variety of feet. As a result, conventional footwear provides a rough fit for a person's foot but does not provide a personalized fit for a person's specific foot shape and arrangement. In performance activities, such as cycling, skiing, snowboarding, skating, etc., the associated footwear must allow for efficient force and load transfer between the wearer's foot, ankle, and lower leg to the associated equipment (i.e., pedals, skis, boards, blades, wheels, etc.). If the footwear is inefficient or does not adequately facilitate the force and load transfer, performance of the activity can substantively suffer.

### BRIEF DESCRIPTION OF THE DRAWINGS

FIG. 1 is a schematic view of a foot, ankle, and lower leg of a human wearer.

FIGS. 2A and 2B are medial- and lateral-facing front isometric views, respectively, of a footwear assembly configured in accordance with embodiments of the present technology.

FIG. 2C is an exploded isometric view of the footwear assembly of FIG. 2A, with a closure device not shown for purposes of illustration.

FIG. 2D is a top plan view of the footwear assembly of FIG. 2A.

FIG. 2E is an isometric cross-sectional view taken substantially along line 2E-2E of FIG. 2D.

FIGS. 3A is a front isometric view of a plantar shell assembly including a panel system configured in accordance with embodiments of the present technology.

FIG. 3B is a medial-facing isometric view of a footwear assembly and the panel system of FIG. 3A.

FIG. 4A is a side view of a lateral engagement panel configured in accordance with embodiments of the present technology.

FIG. 4B is a cross-sectional view taken substantially along line 4B-4B in FIG. 4A.

FIG. 4C is a cross-sectional view illustrating a panel attachment mechanism in accordance with embodiments of the present technology.

FIG. 5A is a schematic illustration of rotation of a wearer's leg and foot at illustrated portions of a pedal cycle.

FIG. 5B is a schematic illustration of the foot position with rotation blocked by a footwear assembly at illustrated portions of a pedal cycle in accordance with aspects of the present technology.

FIGS. 6A and 6B are schematic views of the dorsiflexion angles of a wearer's lower leg and ankle at portions of a pedal cycle.

### DETAILED DESCRIPTION

The present technology provides footwear assemblies configured with a precise, personalized, performance fit for each wearer, along with associated manufacturing processes that overcome problems and drawbacks experienced by the prior art and that provide other benefits. A footwear assembly in accordance with embodiments of the present technology provide a personalized footwear cage system with a plantar shell assembly coupled to a dorsal shell assembly. When coupled together, the plantar and dorsal shell assemblies define an interior area shaped and sized to receive and contain a wearer's foot and an opening in the top area of the footwear configured to allow the user to insert or remove the foot from the interior area. The plantar shell assembly includes a plantar shell and a panel system having one or more engagement panels coupled to the plantar shell. The personalized, customized dorsal shell assembly at least partially covers the plantar shell assembly and extends over a dorsal portion of the wearer's foot. The dorsal shell assembly can include one or more dorsal shells configured to be coupled together and/or secured to the plantar shell. When coupled to the plantar shell, the one or more dorsal shells can firmly seat the wearer's foot in and at least partially against the plantar shell. For example, the dorsal shell can be configured so that, when the dorsal shell is in the closed position, it effectively keeps the sole of the wearer's foot in firm contact with the footbed of the plantar shell, thereby minimizing lift of the foot within the footwear to provide superior and constant ground reaction force(s).

Both the plantar shell assembly, including the plantar shell and the engagement panels, and the dorsal shell assembly can be custom fit to the specific shape, size, and arrangement of the individual wearer's foot, such as from a 3-D foot scan, so as to precisely fit the wearer's foot. Even though the construction of the plantar shell and the dorsal shell assembly are highly personalized and provide improved comfort and/or performance, the engagement panels can allow the wearer or other user to specifically tune or refine (e.g., further tune) the fit of the footwear assembly, such as for use in very dynamic activities. For example, one or more of the engagement panels can be configured to contact selection regions of the foot and/or lower leg to limit or prevent movement (e.g., dorsiflexion, pronation, supination, etc.) of the foot and/or lower leg relative to the footwear assembly. The configuration, shape, stiffness, elastic modulus, and/or other material properties of one or more of the engagement panels can be selected to tune the degree to which the engagement panels restrict these movements of the foot and/or lower leg. The offset, thickness, and/or position of one or more of the engagement panels can be used to maintain and/or move the wearer's foot into a neutral position, for example, to correct for or block pronation and/or supination and/or improve the efficiency of force and/or load transfer between the wearer's foot and the environment and/or equipment interacting with the footwear assembly. This configuration to provide or maintain a desired neutral medial/lateral alignment of the wearer's foot provides more efficient biomechanical function and force generation by the wearer's foot and leg anatomy. Accordingly, these and/or other properties of the engagement panels can be selected to tune the footwear assembly for use in a given highly dynamic activity, such that the configuration of the engagement panels may vary between users and/or highly dynamic activity types.

Accordingly, the configuration and engagement between the engagement panels and the plantar and dorsal shells create a precision-fit caging system that securely contains and controls the wearer's foot, particularly during dynamic activities and motions. For example, the dorsal shell assembly, when in the closed position over the plantar shell, firmly engages one or more of the engagement panels with medial, lateral, and/or dorsal surfaces of the foot, such that the dorsal shell and the engagement panels compress and pre-load the wearer's foot within the caging system to control or limit movement of the wearer's foot relative to the plantar and/or dorsal shell assemblies and provide efficient force transfer from the wearer's foot to the plantar shell during use of the footwear assembly.

The footwear assembly can include one or more closure devices coupled to the plantar and/or dorsal shell assemblies to releasably hold the dorsal shell assembly closed and to apply pressure to select surfaces of the wearer's foot via the engagement panels. The closure device can be released to allow one or more of the dorsal shells to be moved to an open position to allow the wearer to remove their foot from the footwear assembly.

The footwear of the present technology is constructed specifically for the wearer's foot by 3-D printing (or other additive manufacturing techniques) of the plantar and dorsal shell assemblies based on a 3-D scan or other 3-D model of the wearer's foot. Other embodiments can utilize other manufacturing techniques, including non-additive manufacturing, while still providing the personalized construction and fit for the particular wearer's foot. The footwear assembly can be a shoe, boot, sandal, mule, or other footwear style.

Several specific details of the personalized footwear technology and associated fitting and manufacturing processes of the present technology are set forth in the following description and the Figures to provide a thorough understanding of certain embodiments of the invention. One skilled in the art, however, will understand that the present invention may have additional embodiments, and that other embodiments of the invention may be practiced without several of the specific features described below. Further, at least some aspects of the present technology can be generally similar or identical in structure and/or function to one or more features of the personalized footwear disclosed in Applicant's U.S. Patent Application Publication No. US2022-0248807, filed Feb. 11, 2022, titled Personalized Footwear with Integrated Caging System, and in Applicant's U.S. Patent Application Publication No. US2023-0038740, titled Personalized Footwear Assembly with Alignment Panels. Both of the above-identified applications are incorporated by reference herein in their entireties. The technology of the present disclosure provides additional advancements to footwear technologies, including cycling shoe technologies.

Although certain aspects of the present technology are described and/or illustrated with reference to a left foot or a right foot of a wearer, a person of ordinary skill in the art will appreciate that the present technology can be used with another of the wearer's feet, and/or with both of the wearer's feet. For example, at least some embodiments of the present technology can include a first personalized footwear assembly customized for the wearer's left foot and/or a second personalized footwear assembly customized for the wearer's right foot.

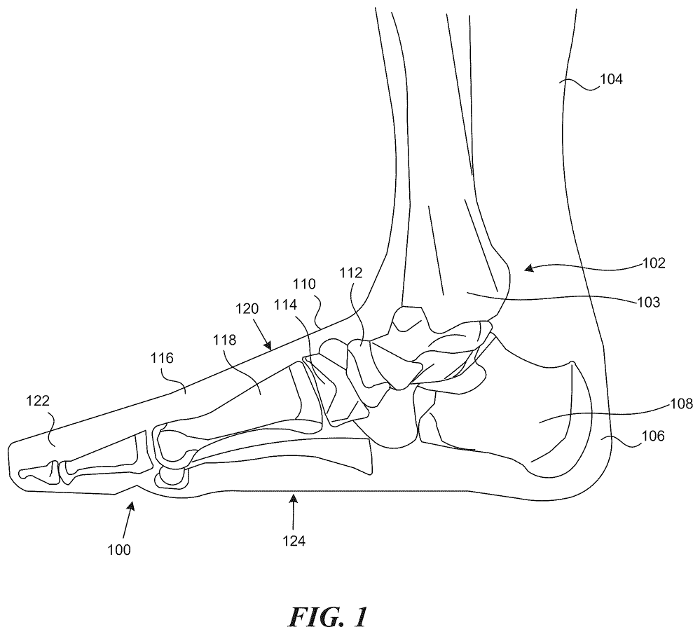

For purposes of discussion and reference, FIG. 1 is a schematic view of a person's foot 100, ankle 102, and lower leg 104. The foot 100 has a heel portion 106 including the calcaneus bone 108, an instep portion 110 including the navicular and cuneiform bones 112 and 114, and a forefoot portion 116 including the metatarsals bones 118. The top 120 of the foot 100 extends from the ankle 102, over the instep portion 110, to the toes 122. The sole 124 of the foot 100 extends from the ankle 102 to the toes 122, but opposite the top 120 of the foot 100 and inferior to the metatarsals bones 118. The lower leg 104 includes a malleolus 103 at medial and lateral sides of the ankle 102.

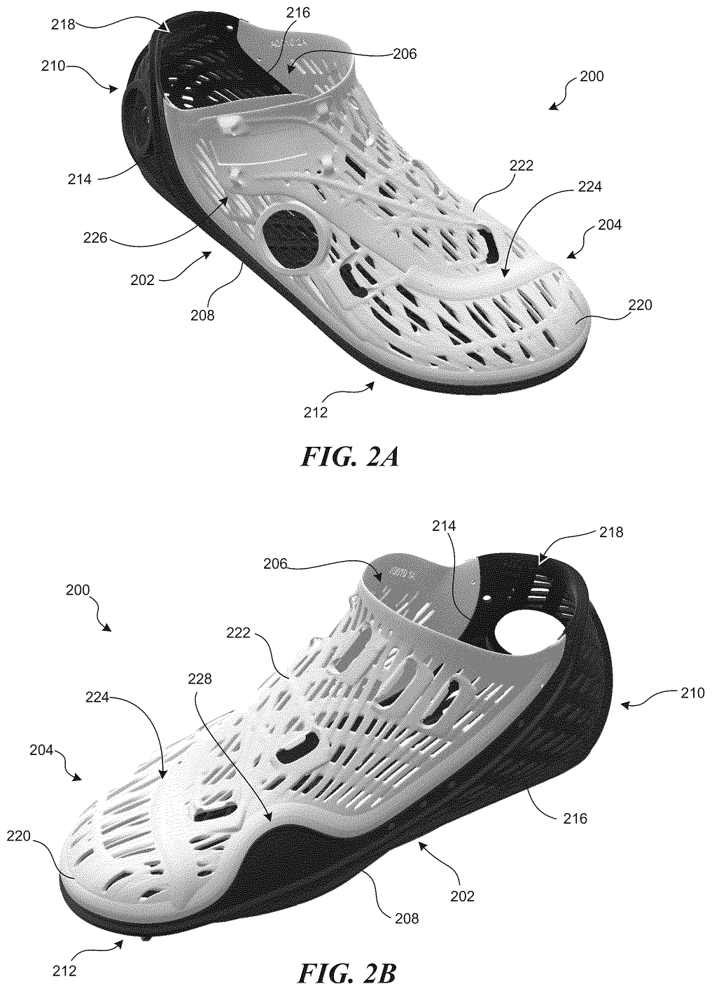

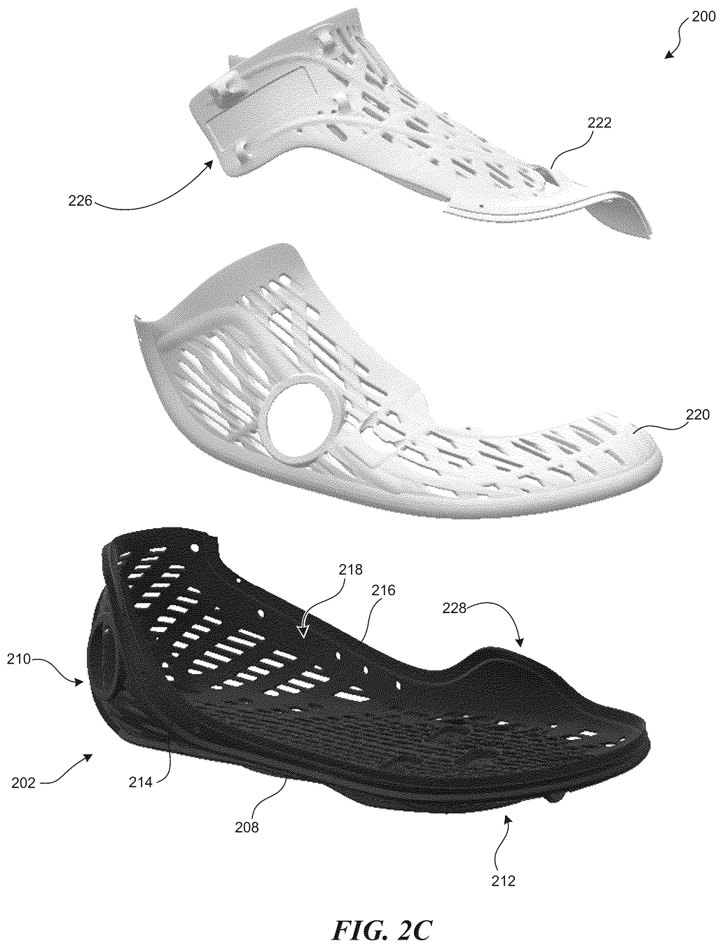

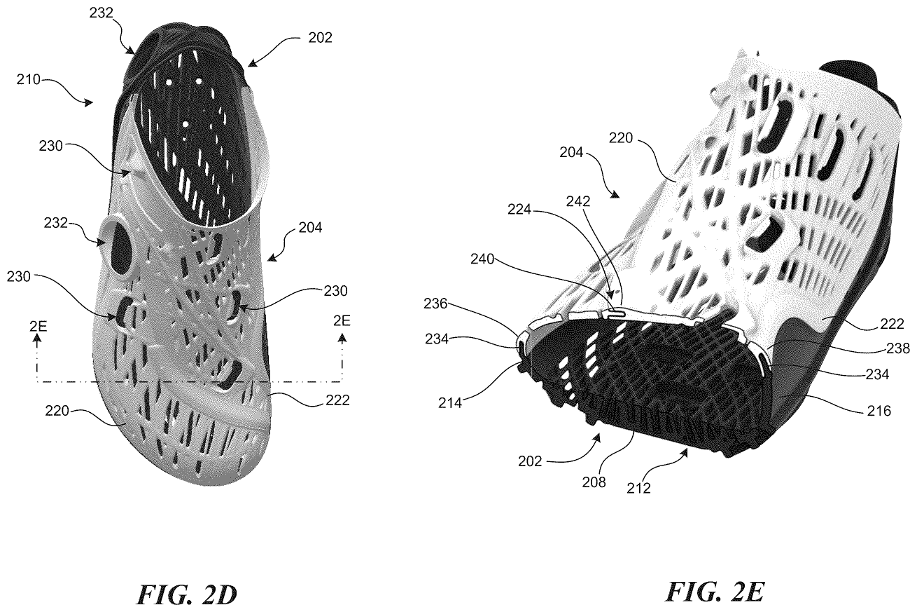

FIGS. 2A and 2B are medial- and lateral-facing front isometric views, respectively of a footwear assembly 200 configured in accordance with an embodiment of the present technology. FIG. 2C is an exploded isometric view of the footwear assembly 200. The footwear assembly 200 comprises a plantar shell assembly 202 and a dorsal shell assembly 204, each of which can be personalized to provide a precise and comfortable fit for a particular wearer's foot 100 (FIG. 1). The dorsal shell assembly 204 can be configured to be releasably coupled to the plantar shell assembly 202 to define an interior 206 of the footwear assembly 200 configured to receive the wearer's foot 100. When the plantar and dorsal shell assemblies 202 and 204 are coupled together and the wearer's foot 100 is positioned within the interior 206, the dorsal and plantar shell assemblies 202, 204 can engage, capture, and retain the foot 100 in a comfortable and secure manner to facilitate performance in highly dynamic sports and other activities. For example, the footwear assembly 200 illustrated in FIGS. 2A and 2B is a cycling shoe configured to facilitate use in cycling. In other embodiments, the footwear assembly 200 can be configured to facilitate use in skiing, snowboarding, skating, climbing, hiking, running, riding, and other activities. The footwear assembly 200 is configured to minimize movement of the foot 100 (FIG. 1) within the interior 206 to facilitate extremely efficient and precise load transfer between the wearer's foot 100 and equipment, such as pedals, skis, a snowboard, a skate blade, wheels, the ground, or other external environments or components. The personalized construction of the footwear assembly 200 for the particular wearer's foot also allows for constructing an extremely comfortable fit around the wearer's foot substantially without sacrificing performance of the footwear assembly 200. It is noted that the foot 100 for which the footwear assembly 200 is built may be a bare foot, a socked foot, a liner-covered foot, or other covered foot configuration.

The plantar shell assembly 202 includes a plantar shell 208 with (i) a contoured heel portion 210 configured to receive and securely retain the foot's heel portion 106 (FIG. 1) and (ii) a sole portion 212 configured to receive and support the foot's sole 124 (FIG. 1). Lateral and medial sidewalls 214, 216 of the plantar shell 208 extend between and/or at least partially around the heel and sole portions 210 and 212. The lateral and medial sidewalls 214, 216 are sized so that, when the wearer's foot is resting on the plantar shell 208, at least the top 120 (FIG. 1) of the foot 100 (e.g., including the instep portion 110 and/or the forefoot portion 116) is exposed through the opening 218 between the sidewalls 214, 216. The plantar shell 208 defines a portion of an upper opening 218 at least partially between the lateral and medial sidewalls 214, 216 and through which the wearer can insert or remove his or her foot from the interior 206.

In some embodiments, the medial sidewall 216 of the plantar shell 208 includes a metatarsal contact portion 228 (FIG. 2B). The metatarsal contact portion 228 can extend upwardly from the sole portion 212 of the plantar shell 208 and can be positioned immediately adjacent to a first metatarsal of the wearer's foot 100. As described in greater detail below, as the wearer moves their foot 100 during highly dynamic activities such as cycling, the foot 100 will tend to move (e.g., rotate, shift, tilt, etc.) relative to the footwear assembly 200 unless that movement is constrained. The metatarsal contact portion 228 is positioned to block or constrain movement of the wearer's foot 100 in the medial direction, such that the plantar shell 208 can prevent, or at least partially limit, medial rotation of the forefoot portion of the wearer's foot 100. This engagement with the metatarsal contact portion 228 is such that forces from the wearer's foot 100 against the metatarsal contact portion 228 can be transmitted directly to the plantar shell 208 to improve and facilitate the load and force transfer efficiency between the foot 100, the footwear assembly 200, and/or any other external equipment (e.g., a bicycle pedal) or environment involved in the highly dynamic activity. Conventional footwear configurations often include soft uppers that position flexible materials adjacent to the first metatarsal, reducing force and load transfer efficiency to improve the wearer's comfort and/or provide a more universal fit. The footwear assemblies of the present technology can improve comfort and maximize both force and load transfer efficiency. For example, the metatarsal contact portion 228 can be at least generally rigid, or otherwise substantially resistant to flexing deformation during use, to improve and facilitate the force and load transfer efficiency between the foot 100, the footwear assembly 200, and/or any other external equipment (e.g., a bicycle pedal) or environment involved in the highly dynamic activity. Additionally, as described above, the personalized construction and fit of the plantar shell 208 can improve the wearer's comfort.

The dorsal shell assembly 204 of the illustrated embodiment can include a first or lateral dorsal shell 220 and a second or medial dorsal shell 222. The lateral and medial dorsal shells 220, 222 can be generally flexible, or at least more flexible than the plantar shell 208. For example, the lateral and medial dorsal shells 220, 222 can be formed from Nylon (e.g., power-based Nylon), reinforced Nylon materials (e.g., fiber-reinforced Nylon), other suitable polyamides, synthetic polymers, thermoplastic polyurethane (TPU) (e.g., powder-based TPU), other plastics, and/or a combination of suitable materials. The lateral dorsal shell 220 can be coupled to plantar shell 208 at least partially along the lateral side wall 214. The medial dorsal shell 222 can be coupled to the plantar shell 208 at least partially along the medial side wall 216. The lateral dorsal shell 220 can be coupled (e.g., connected, adhered, etc.) to the medial dorsal shell 222 along an interface or joint 224. In the illustrated embodiment, a portion 226 of the medial dorsal shell 222 overlaps (e.g., is positioned superior to) at least a portion of the lateral dorsal shell 220 when the lateral and medial dorsal shells 220 and 222 are coupled together. In these and/or other embodiments, a portion of the lateral dorsal 220 can overlap (e.g., be positioned superior to) at least a portion of the medial dorsal shell 222. The wearer can use the overlapping portion 226 to manipulate the medial dorsal shell 222 to, for example, access the interior 206 when donning or removing the footwear assembly 200.

The lateral dorsal shell 220 and/or the medial dorsal shell 222 can be movable between an open position and a closed position. For example, the lateral dorsal shell 220 and/or the medial dorsal shell 222 can be generally flexible, or at least more flexible than the plantar shell 208, and configured to bend or flex relative to the plantar shell 208 to allow the wearer to position their foot through the opening 218. In some embodiments, the lateral dorsal shell 220 and/or the medial dorsal shell 222 can be pivotally attached to the plantar shell 208 (e.g., via a living hinge, a pinned hinge, or other hinge mechanism) to allow the wearer to move the lateral dorsal shell 220 and/or the medial dorsal shell 222 between the open and closed positions. When the lateral dorsal shell 220 and/or the medial dorsal shell 222 are in the open position, the wearer can insert or remove his or her foot from the interior 206. For example, the wearer can move his or her foot 100 at least partially between the lateral and medial dorsal shells 220 and 222 and through the opening 218. Once the wearer's foot 100 is seated firmly against the plantar shell 208 (e.g., with the heel portion 106 of the foot 100 pressed against the heel portion 210 of the plantar shell 208, the sole 124 of the foot 100 resting on the sole portion 212 of the plantar shell 208, etc.), the wearer can move the lateral dorsal shell 220 and/or the medial dorsal shell 222 to the closed position. In the closed position, the lateral dorsal shell 220 and/or the medial dorsal shell 222 positioned over and cover the top 120 of the person's foot. The plantar and dorsal shell assemblies 202 and 204 are sized so that, when the lateral dorsal shell 220 and/or the medial dorsal shell 222 are in the closed position, the foot 100 is firmly yet comfortably captured between the plantar and dorsal shell assemblies 202 and 204.

The plantar shell assembly 202 of the illustrated embodiment can be 3-D printed using a Nylon material, such as a powder-based Nylon, a fiber-reinforced material (e.g., a printable carbon fiber reinforced Nylon material), or other suitable printable material. The dorsal shell assembly 204 of the illustrated embodiment can be 3-D printed using the same or a different material as used for the plantar shell. For example, the dorsal shell can be 3-D printed with a TPU material or suitable material that may have different stiffness or flexibility as compared to the plantar shell. The arrangement of the material, including material thickness and reinforcement arrangements, can be precisely controlled to provide a stiff, lightweight, and strong footwear specifically personalized for a wearer based on the 3-D scan of the wearer's foot. In some embodiments, the plantar and/or dorsal shell assemblies 202 and 204 can be made of fiber-reinforced 3-D printing material from Orbital Composites, Inc., although other materials, such as one or more plastics, rubbers, carbon fiber composites, and/or any of the other materials described herein, from other sources could be used. In some embodiments, the 3-D scan is obtained using a scanning system from Scandy, LLC, although other 3-D scanners, scanning systems, and/or scanning techniques can be used to obtain the specific data about the foot's shape, size, and contours needed to build the personalized footwear. For example, some embodiments could use a 3-D mold, impression, or layup of the wearer's foot to provide 3-D model data for manufacturing the personalized footwear. Additionally, or alternatively, other imaging techniques, cameras, depth sensors and/or photogrammetry tools can be used to provide the 3-D model data. Building the personalized plantar and dorsal shell assemblies 202 and 204 via 3-D printing or one or more other additive or non-additive manufacturing processes to very closely correspond to the wearer's foot allows the footwear assembly 200 to have a precise biometric fit to the wearer's foot. This minimizes the excess space around the foot within the interior 206. As a result, the footwear assembly 200 does not need to sacrifice stiffness for purposes of comfort. In some embodiments, the plantar shell assembly 202 and/or the dorsal shell assembly 204 can have an external shell material and a selected inner liner, such as neoprene, a textile material, a non-textile material, a foam/padding, or other liner feature on the inside surface of the associated shell assembly.

Forming the dorsal shell assembly 204 from separate lateral and medial dorsal shells 220 and 222 can advantageously reduce the print size of the dorsal shell assembly 204 by, e.g., allowing the lateral and medial dorsal shells 220 and 222 to be formed individually and/or with a less complicated printing process. In some embodiments, having separate lateral and medial dorsal shells 220 and 222 can make the footwear assembly 200 easier to repair, replace, or otherwise adjust because these components can be interchangeably removed and/or replaced individually. This interchangeably, in turn, makes it easier to tune the construction of the dorsal shell assembly 204 to provide a precise fit for the wearer's foot, such as during a highly dynamic activity, notwithstanding the fact that an initial 3-D scan of the wearer's foot provides data about the foot in a static condition. Accordingly, the adjustability and tunability of the footwear enables the footwear to utilize, accommodate, and/or control the wearer's specific biomechanical patterns and tendencies (e.g., rotation, pronation, supination, etc.) during the ranges of dynamic activities, which can help maintain a neutral orientation if desired for the wearer's particular movement. In some embodiments, the lateral and medial dorsal shells 220 and 222 can be combined into a single or single-piece dorsal shell including at least some or all of the features of the lateral dorsal shell 220 and/or the medial dorsal shell 222 described herein.

FIG. 2D is a top plan view of the footwear assembly 210. The plantar shell assembly 202 and/or the dorsal shell assembly 204 of the illustrated embodiment can include one or more features configured to receive or otherwise interface with one or more closure mechanisms. For example, the lateral and medial dorsal shells 220, 222 define one or more openings or anchor points 230 configured to receive one or more wires or cables of a releasable cable and dial system, such as a closure system provided by Boa Technology Inc., referred to herein as a Boa closure. The plantar shell assembly 202 and/or the dorsal shell assembly 204 can include one or more mounting points 232 configured to receive an adjustment dial of the Boa closure configured to tighten or loosen the cable threaded through anchor points 230. When the Boa closure is loosened, the lateral dorsal shell 220 and/or the medial dorsal shell 222 can be moved between the closed and opened positions. When the adjustment dial is activated to tighten the cable, the cable tightens over the lateral dorsal shell 220 and/or the medial dorsal shell 222 to lock the lateral dorsal shell 220 and/or the medial dorsal shell 222 in the closed position. Other examples of suitable closure systems include webbings, textile straps, hook and loop fasteners, magnets, buckles, cables, etc.

FIG. 2E is an isometric cross-sectional view of the footwear assembly 200 taken substantially along line 2E-2E in FIG. 2D. The dorsal shell assembly 204 can be coupled to the plantar shell 208 via a perimeter engagement portion 234 that extends around the sole portion 212 along the lateral and medial sidewalls 214 and 216. The engagement portion 234 is configured to mateably engage with a perimeter edge portion 236 of the lateral dorsal shell 220 and/or a perimeter edge portion 238 of the medial dorsal shell 222 when the lateral dorsal shell 220 and/or the medial dorsal shell 222 are in the closed position. The plantar shell's engagement portion 234 of the illustrated embodiment includes a tab or mating ridge extending upwardly from the lateral and medial sidewalls 214 and 216. The lateral dorsal shell's perimeter edge portion 236 has a mating shape that securely engages the plantar shell's engagement portion 234, so as to fixedly retain the lateral dorsal shell 220 in alignment with the perimeter edge portion 236 of the plantar shell 208. Additionally, the medial dorsal shell's perimeter edge portion 238 has a matting shape that securely engages the plantar shell's engagement portion 234, so as to fixedly retain the medial dorsal shell 222 in alignment with the perimeter edge portion 236 of the plantar shell 208. In some embodiments, the dorsal shells may be finely tuned based on known data about the wearer's foot and/or leg anatomy so the dorsal shell may be permanently or removably mated with the plantar shell's engagement portion 234 to provide a close, customized fit around the wearer's foot.

In the illustrated embodiment, the engagement portion 234 of the plantar shell 208 has generally orthogonal engaging surfaces (e.g., horizontal and vertical surfaces) that fit into and securely press against the edge portions 236 and 238 of the lateral and/or medial dorsal shells 220, 222 when the lateral and/or the medial dorsal shells 220, 222 are the closed position. In these and other embodiments, the plantar shell 208, the lateral dorsal shell 220, and/or the medial dorsal shell 222 can include one or more registration features, which could be a portion of the engagement portion 234, the edge portions 236, 238, or other features configured to aid in positioning the lateral dorsal shell 220 and/or the medial dorsal shell 222 relative to the plantar shell 208. For example, the plantar shell 208 can include a first registration feature, the lateral dorsal shell 220 and/or the medial dorsal shell 222 can include a second registration feature, and the first registration feature can be configured to receive the second registration feature when the lateral dorsal shell 220 and/or the medial dorsal shell 222 is aligned with the plantar shell 208. Although the plantar shell's engagement portion 234 and the dorsal shell edge portions 236, 238 in the embodiment illustrated in FIG. 2E have the shapes as discussed above, other embodiments can have locking features with different mating and/or locking arrangements configured to establish and maintain the interconnection and/or alignment of the plantar shell 208 and lateral and medial dorsal shells 220, 222 in the closed position.

The lateral dorsal shell 220 can be coupled to the medial dorsal shell 222 at the interface 224 via an engagement feature 240 extending at least partially along the length of the interface 224. The engagement feature 240 of the illustrated embodiment is configured to mateably engage with a corresponding engagement feature 242 of the medial dorsal shell 222 when the lateral dorsal shell 220 and the medial dorsal shell 222 are in the closed position. The lateral dorsal shells' engagement feature 240 can include a tab or mating ridge extending laterally from a medial edge of the lateral dorsal shell 220. The medial dorsal shell's engagement feature 242 can include a groove, channel or mating shape that securely engages the lateral dorsal shell's engagement portion 240, so as to releasably retain the lateral dorsal shell 220 in alignment with the medial dorsal shell 222. Although the engagement portions 240, 242 of the embodiment illustrated in FIG. 2E have the shapes as discussed above, other embodiments can have locking features with different mating and/or locking arrangements configured to establish and maintain the interconnection and/or alignment of the lateral and medial dorsal shells 220, 222 at the interface 224 in the closed position.

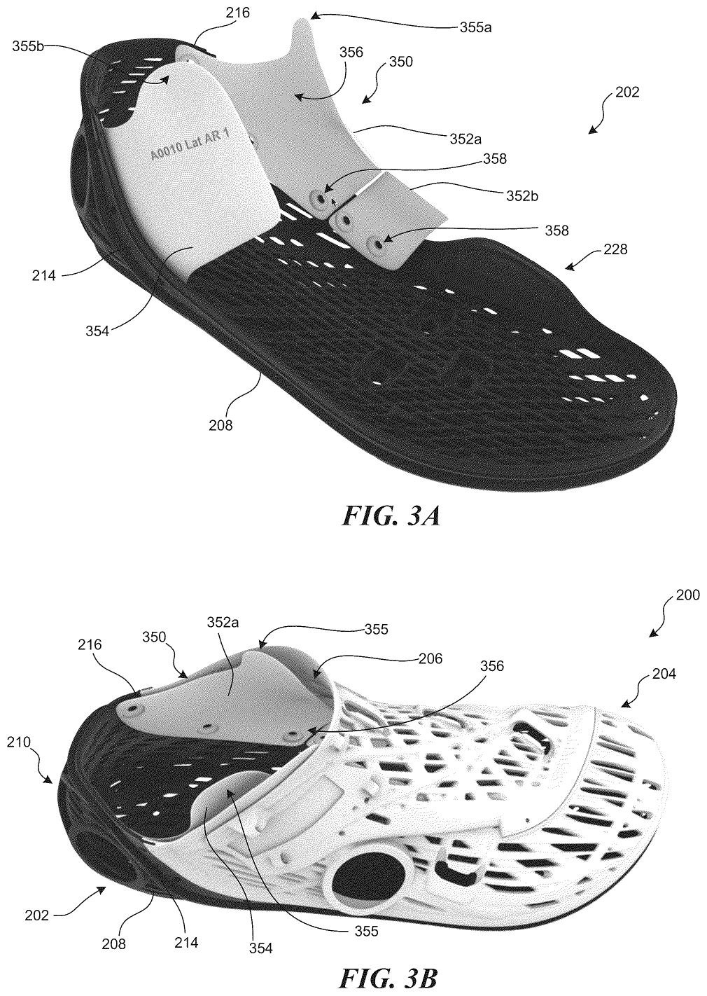

FIG. 3A is a front isometric view of the plantar shell assembly 202 in accordance with embodiments of the present technology. The plantar shell assembly 202 can further include a panel system 350 coupled to the plantar shell 208. The panel system 350 can include one or more medial engagement panels 352 (individually identified as a first medial engagement panel 352a and a second medial engagement panel 352b) and/or one or more lateral engagement panels 354. The panels 352, 354 can be formed from a same or at least generally similar material as the plantar shell 208. For example, one or more of the panels 352, 354 can be a 3D-printable Nylon (e.g., Nylon 12, powder-based Nylon, etc.), reinforced Nylon (e.g., fiber-reinforced Nylon), and/or other materials with suitable properties. In other embodiments, the panels 352, 354 can be made of other materials and/or configurations to provide a desired and tuned flexibility or stiffness for the particular wearer using the customized footwear.

The medial engagement panels 352 can be coupled to the medial side wall 216 of the plantar shell 208. The lateral engagement panels 254 can be coupled to the lateral side wall 214 of the plantar shell 208. One or more of the panels 352 and 354 can extend anteriorly and/or upwardly from the plantar shell 208 such that, when worn, (i) one or more of the medial engagement panels 352 can contact respective medial and/or dorsal regions of the wearer's foot and/or (ii) one or more of the lateral engagement panels 354 can contact respective lateral and/or dorsal regions of the wearer's foot. For example, one or more of the lateral engagement panels 354 can be configured to be aligned with and/or engage at least a portion of a lateral side of a wearer's foot, e.g., generally adjacent to the lateral malleolus portion of the wearer's foot. Additionally, or alternatively, one or more of the medial engagement panels 352 can extending upwardly and/or forwardly from the planter shell 208, generally adjacent to a medial malleolus portion of the wearer's foot (e.g., opposite the lateral malleolus portion). The one or more medial engagement panels 352 can be at least generally similar or identical in structure and/or function to the one or more lateral engagement panels 354, but with respect to different (e.g., opposite) portion(s) and/or side(s) of the wearer's foot. Accordingly, a person of ordinary skill in the art will understand that the one or more medial engagement panels 352 can include at least some or all of the features described with reference to the one or more lateral engagement panels 354, but configured to be aligned with one or more different (e.g., opposite) portions and/or sides of the wearer's foot.

FIG. 3B is a medial-facing isometric view of the footwear assembly 200 and the panel system 350. The panels 352 and 354 can be positioned anterior to the heel portion 210 to engage the instep portion 110 (FIG. 1) of the wearer's foot and/or an anterior surface of the wearer's lower leg 104. The panels 352 and 354 can be positioned within the interior 206 of the footwear assembly 200, or otherwise inwardly from the dorsal shell assembly 204 so that, when the dorsal shell assembly 204 is coupled to the plantar shell 208 and in the closed position, the dorsal shell assembly 204 can press one or more of the panels 352 and 354 against the select regions of the wearer's foot. The extent to which the panels 352 and 354 contact the foot can be based, at least in part, on an offset or other distance between the panels and the expected location of the wearer's foot in the plantar shell based on the scan data of the wearer's foot in a static position. For example, the plantar shell can be configured with a positive offset so the panels 352 and 354 will be spaced apart from a portion of the wearer's foot by a selected distance when the wearer's foot is in the expected static position. At a zero offset, the panels 352 and 354 would be positioned immediately adjacent to, or just in contact with, the expected position of the wearer's foot based on the 3-D foot scan data. Accordingly, the panels 352 and 354 in the positive or zero offset condition would not provide compressive or lateral loads to the wearer's foot when the wearer's foot is in the static position used during the foot scan. In some embodiment, one or more of the panels 352 and 354 can have a negative offset, wherein the location of some or all of the panel(s) would overlap with or appear to interfere with the expected position of the wearer's foot in the plantar shell based on the foot scan data when the wearer's foot is in in the static position. With the negative offset, the panels 352 and 354 are positioned so that, when the wearer inserts his/her foot into the footwear, the wearer's foot will physically press against some or all of the panel having the negative offset. As a result, the panel(s) 352 and/or 354 can be configured to apply compressive and/or lateral loads against the foot even before initiating a dynamic activity. This arrangement can be used to preload the wearer's foot to help establish or maintain a desired foot position, such as a neutral position, and to help block movement away from the desired position, such as from pronation, supination, or other rotation. Accordingly, the plantar shell and panels are configured to allow for easy, quick, and accurate micro-tuning of the footwear for the particular wearer and the dynamic activity for which the wearer will be using the footwear.

During performance activities, the foot undergoes dynamic motion and can be subject to significant forces so as to compress the instep and flex the foot's skeletal structure. This motion of the foot can significantly reduce the efficiency of load and force transfer between the foot, the footwear, and the external equipment or environment. However, the personalized plantar shell 208, panel system 250, and dorsal shell assembly 204 closely and firmly contain the wearer's foot 100 in the interior 206 to restrain the foot 100 from excessive linear motion (longitudinal and lateral/medial motion) and rotational motion relative to the footwear assembly 200. For example, when in the closed position over the plantar shell 208, the dorsal shell assembly 204 can firmly engage the panel system 250 with the top instep portion 110 of the foot 100, such that the panel system 350 compresses and pre-loads the instep 110 of the wearer's foot. Pre-loading the foot's instep portion 110 can advantageously improve the efficiency with which forces and/or loads from the wearer's foot are transferred to equipment and/or the environment via the footwear assembly. Improving the efficiency of such force and load transfer can improve the wearer's performance during highly dynamic activities. The precise and personalized fit of the plantar and dorsal shell assemblies 202 and 204 for the specific shape, size, and contour of individual wearer's foot 100 (FIG. 1) allows for an extremely comfortable fit that minimizes pressure points. More generally, the contour and arrangement of the individual engagement panels 352, 354 are based on the wearer's actual foot shape so that the panel system 350 can be constructed to provide specific compressive loads against selected portions of wearer's instep portion 110 (FIG. 1). These directed compressive loads can provide for correction or modification of a foot's alignment, such as pronation, supination, and/or other alignment and/or movement of the foot. For example, the panel system 350 can be constructed to provide a greater compressive load on the upper medial side or on the upper lateral side of the foot's instep area, depending upon the specific anatomy of the wearer's foot, ankle, and lower leg and/or the type of activity for which the footwear assembly 200 is designed. For example, because skiing can involve more intentional leg and foot rotation (e.g., pronation) than cycling, footwear assemblies designed for skiing can be configured to allow more rotation (e.g., restrict pronation to a lesser degree) than footwear assemblies designed for cycling.

The arrangement of the panels 352 and 354 of the illustrated cycling shoe directs loads from the wearer's foot, ankle, and lower leg into the plantar shell 208 to efficiently transfer the loads and associated power to the pedal for increased performance during each pedal cycle. For example, during the pedal cycle, the wearer's foot can undergo dorsiflexive motion, pronation, and/or supination. In conventional cycling shoes, this motion of the wearer's foot moves the wearer's foot relative to the conventional cycling shoe (e.g., the wearer's foot slides or moves within the conventional cycling shoe) and/or cause the wearer's foot to deform the conventional cycling shoe. In contrast to conventional cycling shoes, the cycling shoe assembly 200 of the present technology can capture (e.g., inhibit or prevent) at least part or all of the dorsiflexive, pronation, and/or supination motion of the wearer's foot and direct loads and associated power associated with this motion to the pedal. More specifically, one or more of the medial engagement panels 352 and/or one or more of the lateral engagement panels 354 can be positioned to capture (e.g., inhibit or prevent) pronation and/or supination motion of the wearer's foot, e.g., without or substantially without allowing the wearer's foot to (i) move relative to the cycling shoe assembly 200 and/or (ii) substantively deform the cycling shoe assembly 200. Additionally, or alternatively, one or more of the panels 352 and 354 can be positioned to capture (e.g., inhibit or prevent) dorsiflexive motion of the wearer's foot.

Accordingly, the plantar shell assembly 202, including the personalized plantar shell 208, metatarsal contact portion 228, and panel system 350, can define a customized rigid caging system configured to securely and comfortably contain the wearer's foot and increase the efficiency of forces and loads transferred from the wearer's foot 100 to the environment during highly dynamic activities. The dorsal shell assembly 204 can help secure the plantar shell assembly 202 against the wearer's foot to, e.g., further improve comfort and/or force and load transfer efficiency. In some embodiments, the panel system 350 is itself sufficient to secure the wearer's foot 100 to the plantar shell 208 and the dorsal shell assembly 204 can be minimized. For example, the panel system 350 can define a rigid personalized upper that contacts dorsal surfaces of the wearer's foot 100 to comfortable and securely hold the wearer's foot in place relative to the plantar shell 208. Straps, cables, and/or other closure devices can be included as needed to further improve the wearer's comfort and/or performance.

In the illustrated embodiment the panel system 350 includes a gap 356 between the medial and lateral engagement panels 352, 354. When worn, the gap 356 can be at least partially aligned with the instep portion 110 of the wearer's foot. The gap 356 can provide a center relief into which the wearer's lower leg can flex. The center relief can be configured to avoid pressure on tendons or other potentially sensitive areas of the ankle and lower leg while still allowing the panels 352, 354 to engage the instep portion 110 of the foot 100. In some embodiments, the gap 356 can be omitted and the medial and lateral engagement panels 352 and 354 can be combined into a single or single-piece engagement panel (including, e.g., the instep engagement portion) that can extend at least partially or fully between the lateral and medial side walls 214 and 216 of the plantar shell 208 to engage select regions on lateral, dorsal, and/or medial sides of the wearer's foot.

Various aspects of individual panels 352, 354, including the size, shape, stiffness, thickness, and/or number of panels on the medial and/or lateral side of the wearer's foot 100, can be customized based on a specific wearer's foot 100 to improve (or maximize) the wearer's comfort while also improving (or maximizing) the wearer's performance during highly dynamic activities. For example, the offset and/or the thickness of one or more of the panels 352, 354 can be selected to adjust the lateral positioning and/or alignment of the wearer's foot 100 relative to the plantar shell 208. In another example, one or more of the engagement panels 352, 354 can be configured to provide a desired amount of stiffness at various contact points along the foot in accordance with the selected performance and comfort for the personalized footwear assembly 200. One or more of the engagement panels 352, 354 can be stiffer than the lateral and/or medial dorsal shells 220, 222 but may be less stiff than the plantar shell 208. That is, one or more of the engagement panels 352, 354 can have a first elastic modulus (e.g., a first elastic modulus selected from a first range of elastic moduli between 1 GPa and 10 GPa, such as from 1.2 GPa to 5 GPa, or from 1.5 GPa to 3 GPa) and the lateral and/or medial dorsal shells 220, 222 can have a second elastic modulus (e.g., a second elastic modulus selected from a second range of elastic moduli between 10 MPa and 1000 MPa, such as from 20 MPa to 500 MPa, or from to 30 MPa and 100 MPa) less than the first elastic modulus. The plantar shell 208 can have a third elastic modulus (e.g., a third elastic modulus selected from a third range of elastic moduli between 1 GPa and 70 GPa, such as from 1.5 GPa to 30 GPa, or from 2 GPa to 10 GPa) that is greater than the second elastic modulus. The third elastic modulus of the plantar shell 208 can be greater than the first elastic modulus of one or more of the engagement panels 352, 354 in some embodiments, but in other embodiments the third elastic modulus can be less than or equal to the first elastic modulus of one or more of the engagement panels 352, 354. The relatively increased stiffness of the plantar shell 208 and the engagement panels 352, 354 can allow these components to efficiency transfers forces and loads from the wearer's foot to equipment or the environment during highly dynamic activities. The relatively reduced stiffness of the medial and lateral dorsal shells 220, 222 can help to hold the engagement panels 352, 354 against the wearer's foot 100 while providing a comfortable and contoured fit. In addition to selecting the respective moduli to control the stiffnesses of the engagement panels 352, 354, the lateral and/or medial dorsal shells 220, 222, and/or the plantar shell 208, the thicknesses of the engagement panels 352, 354, the lateral and/or medial dorsal shells 220, 222, and/or the plantar shell 208 can also be selected (e.g., in addition to the moduli) to achieve a desired stiffness, flex patterns, shape configurations, and related tuning for the particular wearer and the associated dynamic activity.

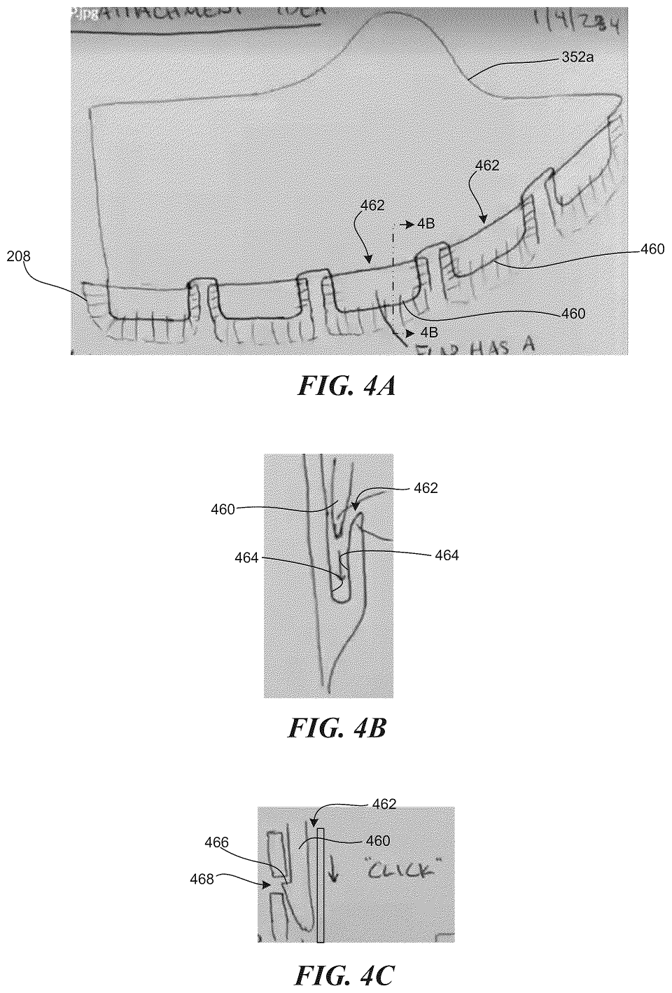

In addition to the individual panels 352, 354 being customizable, one or more of the panels 352 and 354 can be removable and replaced with panels of different sizes, shapes, thicknesses, surface areas, material properties, etc., to achieve desired performance characteristics. For example, stiffer and/or larger panels 352 and 354 are expected to restrict movement of the wearer's foot to a greater degree than panels 352 and 354 that are more flexible, thinner, and/or smaller. In the illustrated embodiment, one or more of the panels 352 and 354 include one or more fastener holes 358 configured to receive screws, push-in rivets, pins, and/or other fasteners to releasably couple the panels 352 and 354 to the plantar shell 208. In other embodiments, one or more of the panels 352 and 354 can be configured to be coupled to the plantar shell 208 using other coupling techniques, including those described below with reference to FIGS. 4A-4C.

FIG. 4A is a side view of the first medial engagement panel 352a configured in accordance with embodiments of the present technology. In some embodiments, instead of the fastener holes 358 (FIGS. 3A and 3B), one or more of the engagement panels 352 and 354 can include one or more fastener tabs 460. The fastener tabs 460 can extend downwardly from the panels 352 and 354 and be shaped to be received by corresponding receiving features or pockets 462 defined by the plantar shell 208. Positioning the fastener tabs 460 within the respective pockets 462 can securely and releasably couple the panels 352 and 354 to the plantar shell 208, as described previously herein.

FIG. 4B is a cross-sectional view taken substantially along line 4B-4B in FIG. 4A. In some embodiments, one or more of the tabs 460 and the pockets 462 are configured to mateably engage via a friction fit. For example, one or more of the pockets 462 can include sidewalls 464 configured to contact one or more of the tabs 460 when the tabs are positioned therein. The contact (e.g., friction) between the tabs 460 and the sidewalls 464 of the pockets 462 can hold the tabs 460 securely within the pockets 462 until a user applies sufficient force to overcome the interference fit and remove the tabs 460 from the pockets 462.

FIG. 4C is a cross-sectional view illustrating another panel attachment mechanism in accordance with embodiments of the present technology. In some embodiments, one or more of the tabs 460 include one or more ridges 466 configured to mateably engage with a corresponding receiving feature or opening 468 within the pocket 462. Accordingly, a user can press the tab 460 into the pocket until the ridge 466 engages and is received at least partially within the receiving feature 468. The contact between the ridge 466 and the receiving feature 468 can hold the tabs 460 securely within the pockets 462 until a user applies sufficient force to overcome the interference fit and remove the tabs 460 from the pockets 462.

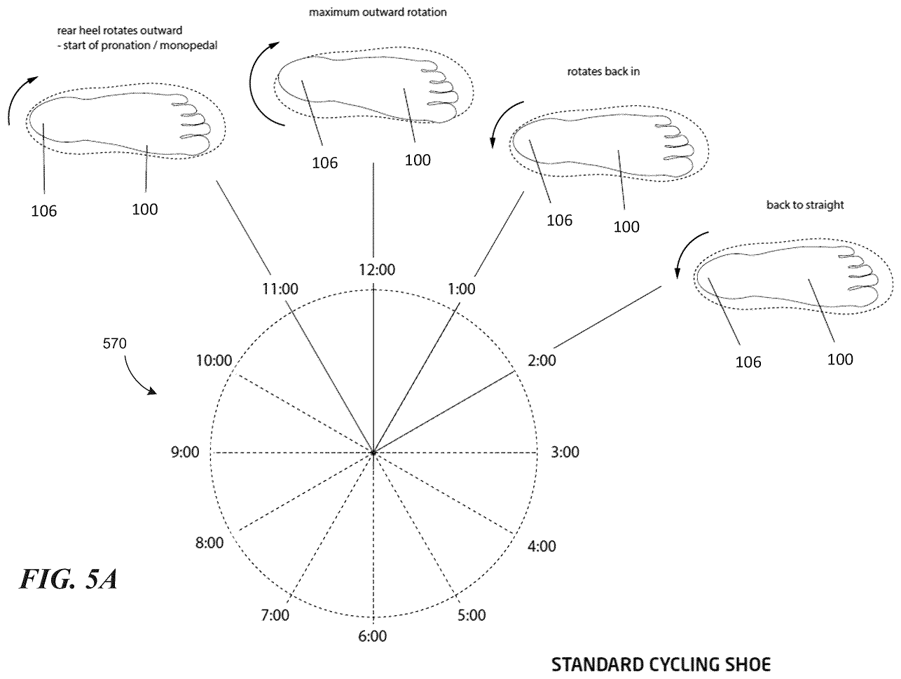

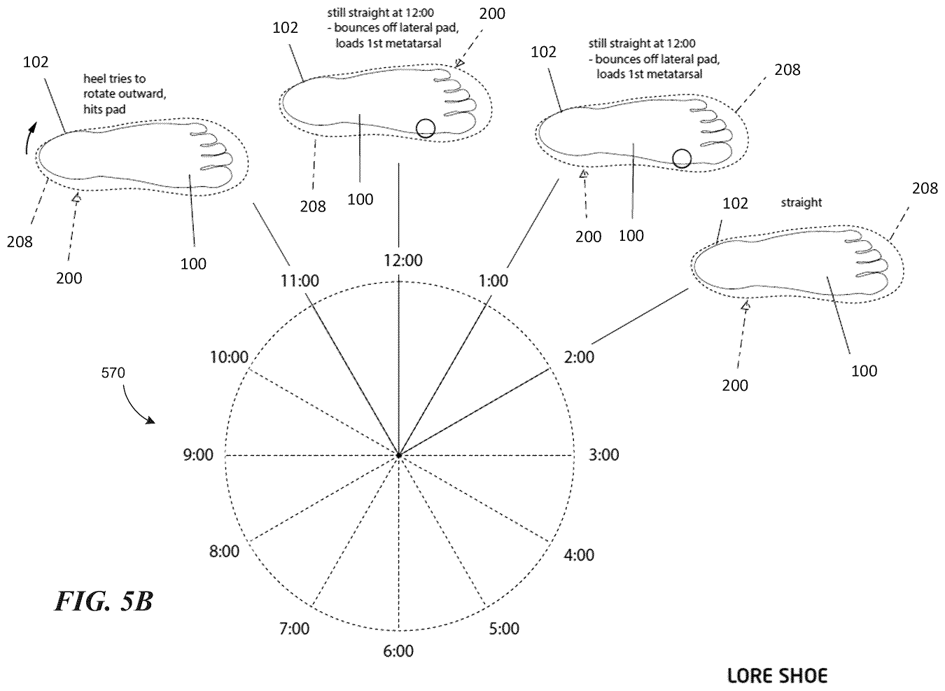

FIG. 5A is a schematic illustration of a rotational position or tendency of a wearer's foot 100 at illustrated portions of a pedal cycle 570 when the wearer's foot 100 is not supported or constrained to remain in the neutral position. The pedal cycle 570 is a full 360-degree rotation of the pedal, which can be described with a clock-face analogy, wherein the top-most position of the pedal cycle 570 corresponds to a 12:00 position (i.e., twelve o'clock), the bottom-most position corresponds to a 6:00 position (i.e., six o'clock), halfway through the down-stroke of the pedal cycle 570 corresponds to a 3:00 position (i.e., three o'clock), and halfway through the up-stroke of the pedal cycle 570 corresponds to a 9:00 position (i.e., nine o'clock). Using this clock-face analogy, when the wearer's foot 100 is on the upstroke approximately at the 11:00 position, the heel 106 of the foot 100 tends to rotate outwardly, which can be the beginning of a pronation movement when the foot 100 is not constrained. As the wearer's foot 100 approaches the 12:00 position, the outward rotational movement of the foot 100 would be approximately at the maximum if the foot 100 is not adequately constrained from the rotational movement. As the wearer's foot 100 moves to approximately the 1:00 position, the wearer's heel 106 begins rotating back in toward a neutral alignment, which is reached by the time the foot 100 is approximately at the 2:00 position.

FIG. 5B illustrates the footwear assembly 200 of the current technology at approximately the same 11:00, 12:00, 1:00, and 2:00 positions. The shoe assembly 200 has a rigid plantar shell assembly 220 including one or more of the lateral engagement panels 354 and the metatarsal engagement portion 228 that block the wearer's foot 100 from rotating away from the neutral position. This results in loading the wearer's forefoot portion, such as at the first metatarsal and/or along a lateral side of the foot, through which power can be transmitted through the rigid plantar shell assembly 202 to the pedal. Accordingly, the wearer's foot 100 substantially remains in the neutral position as the foot 100 transitions from the upstroke to the downstroke and to the power portion of the pedal cycle. A conventional cycling shoe with the soft upper and the general, non-personalized fit cannot provide the optimal fit and energy capture provided by the shoe assembly 200 of the present technology. The illustrated shoe assembly 200 also directs the torsional and lateral loads directly into the plantar shell assembly 202 for pressure equalization and efficient transfer to the pedal earlier in the pedal cycle to more efficiently capture the loads for conversion to additional power during the pedal cycle. The sooner the vertical loads generated by the wearer can be exerted on the pedal after the 12:00 position, the sooner the power portion of the pedal cycle can start. This means that a significantly greater amount of power can be generated during the down stroke of the pedal cycle 570 (i.e., 12:00 position to 6:00 position). Accordingly, the rigid plantar shell assembly 202 with the lateral engagement panels 354 and the metatarsal engagement portion 228 helps maintain that neutral position for efficient power transfer to the pedal, particularly between the downstroke of the pedal cycle.

One or more of the medial engagement panels 352 can block the wearer's foot 100 from rotating, such as pronating away from the neutral position. The wearer's foot 100 can also undergo supination movement (e.g., outward/lateral ankle rotation), in addition to or in lieu of the pronation movement (e.g., inward/medial ankle rotation) described previously. In such embodiments, the configuration of the of the personalized panel system 350, the plantar shell 208 can have one or more of the medial engagement panels 352 that blocks the wearer's foot 100 from excessive pronation and associated rotation in one direction away from the neutral position. Alternatively, the plantar shell 208 can have one or more lateral engagement panels 354 that blocks the wearer's foot 100 from excessive supination and associated rotation in another (e.g., opposite) direction away from the neutral position. This results in loading the wearer's forefoot portion, such as at the first metatarsal, through which power can be transmitted through the rigid plantar shell assembly 202 to the pedal. Accordingly, the wearer's foot 100 substantially remains in the neutral position as the foot 100 transitions from the upstroke to the downstroke and to the power portion of the pedal cycle.

In some embodiments, the plantar shell assembly 202 (including, e.g., the heel portion 210, the metatarsal contact portion 228, and/or the panel system 350) can increase (e.g., maximize) force and/or power transfer to the pedal during the upstroke portion (i.e., 6:00 position to 12:00 position) of the pedal cycle. For example, the plantar shell assembly 202 and/or the dorsal shell assembly 204 can be configured to hold the heel portion 106 of the wearer's foot 100 in contact with the heel portion 210 of the shoe assembly 200, as described previously with reference to FIGS. 3A and 3B. During the upstroke portion, the upward and/or rearward motion of the wearer's foot naturally directs the wearer's heel portion 106 toward the heel portion 210 of the shoe assembly 200. In conventional cycling shoes, this causes the wearer's foot to slide relative to the cycling shoe. In contrast to conventional cycling shoes, because the plantar shell assembly 202 can hold the heel portion 106 of the wearer's foot 100 in constant, firm contact with the heel portion 210 of the shoe assembly 200, the wearer's foot 100 remains in contact with the heel portion 210 of the shoe assembly 200 at the beginning of the upstroke portion (i.e., at the 6 o'clock position). This results in the wearer of the shoe assembly 200 being able to generate power at the beginning of the upstroke portion (i.e., at the 6 o'clock position) and/or without the loss of power/efficiency associated with the foot movement experienced in conventional cycling shoes during the upstroke portion.

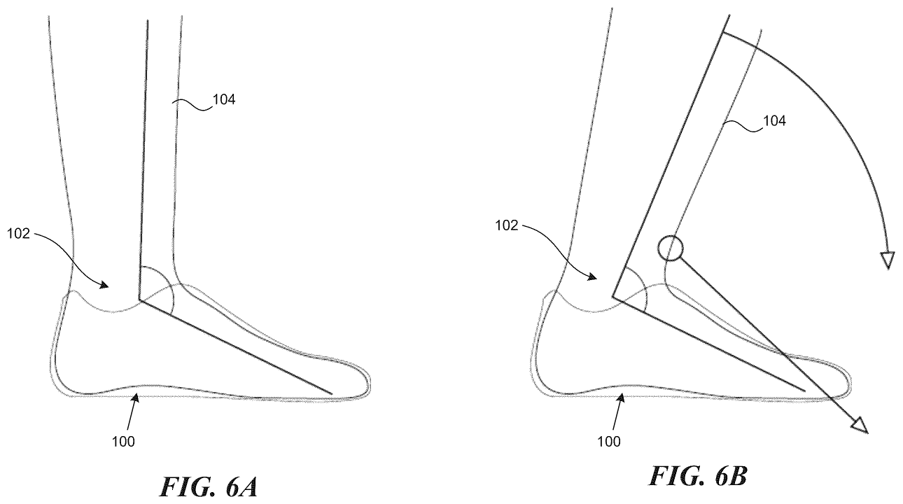

FIGS. 6A and 6B are schematic views of the dorsiflexion angles of a cyclist's lower leg 104 and ankle 102 at portions of the pedal cycle of FIG. 5B. A wearer's ankle 102 moves and flexes during a pedal cycle. For example, a relatively minimum dorsiflex movement (FIG. 6A) occurs during approximately the 9:00-10:00 portion of the pedal cycle (i.e., on the up-stroke). The maximum dorsiflex movement (FIG. 6B) typically occurs as the wearer's foot approaches and moves through the top of the pedal stroke at 12:00 and during approximately the 12:00-3:00 portion of the pedal cycle, which is within the power-generating portion of the pedal cycle. During this maximum dorsiflexion portion, the angle of the wearer's lower leg 104 relative to the foot 100 is decreased (i.e., there is more flex, so the angle is more acute), and the anterior portion of the lower leg moves forwardly toward the wearer's foot 100.

The footwear assembly 200 can capture this dorsiflexive movement and transmit it to external equipment and/or the wearer's environment to improve the wearer's performance during highly dynamic activities. For example, referring again to FIGS. 3A and 3B, one or more of the panels 352 and 354 can include one or more extended instep engagement and/or dorsiflexion portions 355 (individually identified as a first or medial dorsiflexion portion 355a and a second or lateral dorsiflexion portion 355b) extending from the upper posterior portion of these panels 352, 354. The dorsiflexion portions 355 are configured to extend upwardly for engagement with the wearer's lower leg 104 along the portion adjacent to the lateral malleolus, the medial malleolus, and/or the shin, depending on the length of the dorsiflexion portions 355. In the illustrated embodiment, the panel system 350 has dorsiflexion portions 355 configured to be positioned on medial and lateral sides of the centerline of the lower leg 104. Each of the medial and lateral dorsiflexion portions 355 extend upwardly so the wearer's leg will press against the dorsiflexion portion as the amount of flex increases (i.e., the flex angle decreases), particularly as the wearer's foot approaches and moves through the top of the pedal stroke at 12:00 and during the beginning of the power stroke portion of the pedal cycle. The dorsiflexion portions 355 allow for a precise level of fit and load transfer control because the anatomy of the lower leg 104, ankle 106, and foot 100 differ between wearers.

The engagement with the dorsiflexion portions 355 helps maintain the neutral alignment of the wearer's lower leg, ankle, and foot during the pedal cycle. The engagement with the dorsiflexion portions 355 also increases (e.g., maximizes) the load transfer into the rigid plantar shell 208 and to the pedal during the pedal cycle. A height of one or more of the dorsiflexion portions 355 can correspond to a magnitude of the load transferred into the plantar shell 208. For example, dorsiflexion portions 355 that extend further up the wearer's leg are expected to provide increased load transfer/efficiency compared to dorsiflexion portions 355 that extend lesser distances up the wearer's leg.

In some embodiments, individual ones of the panels 352 and 354 can be interchanged with one or more other panels 352 and 354 having dorsiflexion portions 355 of different heights, thicknesses, stiffnesses, offsets, and/or the like. Additionally, or alternatively, one or more of the panels 352 and 354 can be moved, rotated, and/or otherwise repositioned relative to the plantar shell 208 and/or the wearer's foot 100 and/or ankle 108 to improve the fit, comfort, and/or power transfer between the wearer and the dorsiflexion portions 355. For example, a medial dorsiflexion portion 355a having a reduced offset and/or greater thickness compared to the lateral dorsiflexion portion 355b may be beneficial to provide additional support toward the neutral position for a wearer who has greater rotation and linear motion in the lower leg and ankle in the medial direction during the pedal cycle. In another embodiment, a lateral dorsiflexion portions 355b having a reduced offset and/or greater thickness compared to the medial dorsiflexion portion 355a may be beneficial to provide additional support toward the neutral position for a wearer who has greater rotation and linear motion in the lower leg and ankle in the lateral direction, or has less rotation and linear motion in the lower leg and ankle in the medial direction. Accordingly, the dorsiflexion portions 355 may provide a configuration with select orthotic arrangements for the personalized fit of the wearer depending upon the anatomy and typical movement patterns of that wearer's lower leg, ankle and foot during a pedal cycle.

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

As used herein, the word “or” refers to any possible permutation of a set of items. For example, the phrase “A, B, or C” refers to at least one of A, B, and C, or any combination therefore, such as any of A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

We claim:

1. A footwear assembly as described and illustrated herein.

2. A footwear assembly including a customizable pad system as described and illustrated herein.

3. A method of manufacturing a footwear assembly as described and illustrated herein.

4. A method of manufacturing one or more pads for a personalized footwear assembly to improve a wearer's performance during highly dynamic activities, as described and illustrated herein.
